(19) United States
(12) Patent Application Publication
(10) Pub. No.: US 2009/0109317 A1
(43) Pub. Date: Apr. 30, 2009

(54) IMAGE PICKUP APPARATUS

(75) Inventor: KUN-I YUAN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/143,635

(22) Filed: Jun. 20, 2008

(30) Foreign Application Priority Data
Oct. 25, 2007 (CN) 200710202264.5

(51) Int. Cl. H04N 5/225

(52) U.S. Cl. 348/340; 348/E05.024

(57) ABSTRACT

An image pickup apparatus includes a housing, at least one lens, an image sensor and an optical compensation device. The lens is accommodated in the housing. The image sensor is accommodated in the housing. The optical compensation device is disposed between the lens and the image sensor. The optical compensation device includes a first transparent plate, a second transparent plate and at least one piezoelectric element. The second transparent plate is opposite to and movable relative to the first transparent plate. The piezoelectric element is sandwiched between the first transparent plate and the second transparent plate.

### BACKGROUND

1. Field

The invention relates generally to image pickup apparatuses, and particularly to an image pickup apparatus capable of calibrating different pathways of light caused by vibration.

2. Description of Related Art

Currently, portable electronic devices, such as personal digital assistants (PDAs), cellular telephones, etc., are becoming indispensable products for people in modern life. Along with the increasingly widespread use of such devices, there is a demand for developing multifunctional mobile communication terminals. Accordingly, the mobile communication terminal equipped with an image pickup apparatus has been conducted in recent years.

When picking up an image of an object, any vibrations of the image pickup apparatus, e.g. hand shake, may cause blurriness in the image. Specifically, vibrations of the image pickup apparatus may also cause displacement of an optical axis of a lens in the image pickup apparatus. Thus, a location on an image sensor of the image pickup device, which receives light exposing one position of the object, can vary over the period of exposure. In other words, single location of the sensor will constantly receive different image signals corresponding to different positions of the object, thereby causing the image of the object to be blurred or smeared along the direction of the relative motion.

What is needed, therefore, is an image pickup apparatus capable for calibrating displacement of optical pathways and avoid generating blurred images which are due to vibrations occurring thereof.

### SUMMARY

An image pickup apparatus is provided. In one present embodiment, the image pickup apparatus includes a housing, at least one lens, an image sensor and an optical compensation device. The lens is accommodated in the housing. The image sensor is accommodated in the housing. The optical compensation device is disposed between the lens and the image sensor. The optical compensation device includes a first transparent plate, a second transparent plate and at least one piezoelectric element. The second transparent plate is opposite to and movable relative to the first transparent plate. The piezoelectric element is sandwiched between the first transparent plate and the second transparent plate.

Another image pickup apparatus is provided. In one present embodiment, the image pickup apparatus includes a lens, an image sensor, and an optical compensation device. The image sensor is optically aligned with the lens. The optical compensation device disposed between the lens and the image sensor. The optical compensation device includes a first transparent plate, a second transparent plate, and a piezoelectric element. The second transparent plate is substantially parallel to the first transparent plate. The piezoelectric element has a first end coupled to the first transparent plate and an opposite second end coupled to the second transparent plate. The piezoelectric element is deformable in a manner such that the first transparent plate is obliquely oriented relative to the second transparent plate.

Advantages and novel features of the present image pickup apparatus will become more apparent from the following detailed description of preferred embodiments when taken in conjunction with the accompanying drawings.

### BRIEF DESCRIPTION OF THE DRAWINGS

The components in the drawing are not necessarily drawn to scale, the emphasis instead being placed upon clearly illustrating the principles of the present invention.

FIG. 1 is a schematic cross-sectional view of an image pickup apparatus in accordance with a first embodiment of the present invention.

FIG. 2 is a schematic cross-sectional view of the image pickup apparatus of FIG. 1 along a line II-II.

FIG. 3 is a schematic view of illustrating optical paths calibrated by the optical compensation device of FIG. 1.

FIG. 4 is a schematic cross-sectional view of an image pickup apparatus in accordance with a second embodiment of the present invention.

FIG. 5 is a schematic cross-sectional view of the image pickup apparatus of FIG. 4 along a line V-V.

Corresponding reference characters indicate corresponding parts. The exemplifications set out herein illustrate at least one preferred embodiment of the present image pickup apparatus, in one form, and such exemplifications are not to be construed as limiting the scope of the invention in any manner.

### DETAILED DESCRIPTION OF THE EMBODIMENT

Reference will now be made to the drawings to describe embodiments of the present image pickup apparatus in detail.

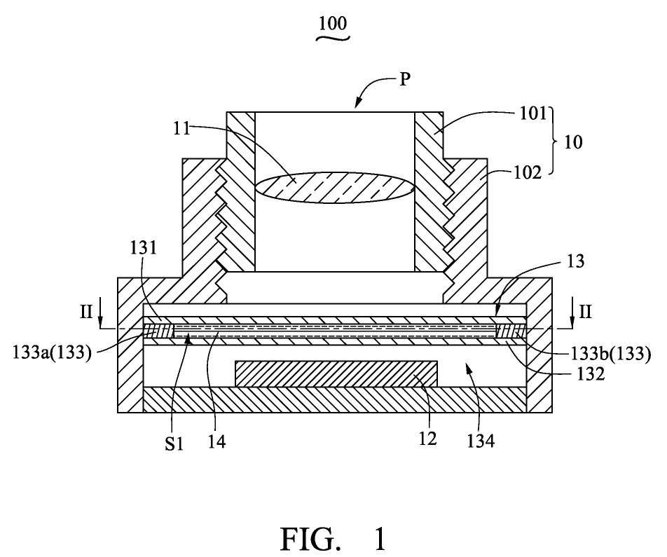

Referring to FIG. 1, an image pickup apparatus 100 in accordance with a first embodiment of the present invention, is provided. The image pickup apparatus 100 includes a housing 10, at least one lens 11, an image sensor 12 and an optical compensation device 13. In the present embodiment, the image pickup apparatus 100 can be installed into electronic devices, such as notebook computers, personal digital assistants (PDAs), or cellular phones.

In the present embodiment, the lens 11, the image sensor 12 and the optical compensation device 13 are accommodated in the housing 10. The optical compensation device 13 is disposed between the lens 11 and the image sensor 12. The lens 11 is disposed adjacent to an opening P provided for allowing light entering thereof. Referring to FIG. 1, the housing 10 includes a barrel 101 and a holder 102 connecting with the barrel 101. The barrel 101 and the holder 102 are made of plastic. The barrel 101 is externally threaded and is received by the internally threaded holder 102. In the present embodiment, the lens 11 is accommodated in the barrel 101 while the image sensor 12 and the optical compensation device 13 are accommodated in the holder 102.

The lens 11 can be an aspherical lens, a spherical lens or a planar lens. In addition, the lens 11 can be made of plastic or glass. The number of lens is not limited to one, a plurality of lenses can also be accommodated in the barrel 101 in practice.

The image sensor 12 is optically aligned with the lens 11. The image sensor 12 is configured to receive light passing through the lens 11. In the present embodiment, the image sensor 12 can be a charge coupled device (CCD) or a complementary metal oxide semiconductor (CMOS).

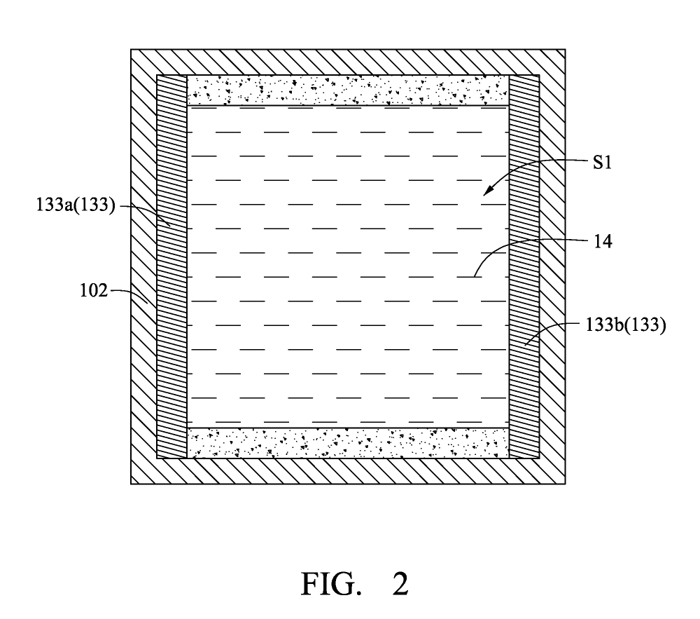

Referring to FIG. 1 and FIG. 2, the optical compensation device 13 includes a first transparent plate 131, a second transparent plate 132 and at least one piezoelectric element 133. The second transparent plate 132 is opposite to the first transparent plate 131. The piezoelectric element 133 is sandwiched between the first transparent plate 131 and the second transparent plate 132. Particularly, the piezoelectric element 133 has a first end coupled to the first transparent plate 131 and an opposite second end coupled to the second transparent plate 132.

The first transparent plate 131 is fixed to the barrel 102, the second transparent plate 132 can be movable relative to the first transparent plate 131. In addition, the first transparent plate 131, the second transparent plate 132 and the piezoelectric element 133 cooperatively form a sealed space S₁. Furthermore, for making sure the sealed space S₁ is air-tight, an elastic element, such as organic silicon gel, polysulfide gel or polyurethane gel, is filled in interfacial gaps formed between the first transparent plate 131, the second transparent plate 132 and the piezoelectric element 133 (not shown).

In the present embodiment, the second transparent plate 132 and the first transparent plate 131 are planar and rectangular-shaped plates. The structures of the second transparent plate 132 and the first transparent plate 131 are designed for fitting within the holder 102. In addition, the first transparent plate 131 and the second transparent plate 132 have high transparency and can be made of glass or plastic. Preferably, the first transparent plate 131 and the second transparent plate 132 are made of quartz glass having an index of refraction of about 1.48.

In the present embodiment, there are two piezoelectric elements 133a, 133b disposed between the first transparent plate 131 and the second transparent plate 132 as example. However, it is understood that operation of the optical compensation device 13 can be achieved by having only one piezoelectric element 133. The piezoelectric elements 133 are made of materials that are deformable when an electric field is applied. In the present embodiment, the piezoelectric elements 133 can be made of piezoelectric ceramic, piezoelectric crystal or piezoelectric polymer. Preferably, the piezoelectric elements 133 are made of the piezoelectric ceramic. Referring to FIG. 2, each of the piezoelectric elements 133a, 133b is in a strip shape. The piezoelectric elements 133a, 133b are disposed at opposite peripheral areas of the first transparent plate 131 and the second transparent plate 132.

In the present embodiment, voltage sources (not shown) are used to connect to both ends of each of the piezoelectric elements 133. The voltage source is configured for supplying an electric current to the piezoelectric element 133. In addition, it is understood that an integrated circuit chip (IC chip) can be utilized to control the operation of the voltage sources and determine the amount of voltage supplied to the piezoelectric elements 133.

When the voltage is applied to the piezoelectric elements 133, the piezoelectric elements 133 generate stress or strain in response to the electric potential. The piezoelectric elements 133 may change shapes, thereby causing the second transparent plate 132 to be obliquely oriented relative to the second transparent plate. As a result, an optical path of the light beam passing through the optical compensation device 13 with slanted second transparent plate 132 onto the image sensor 12 is changed.

The image pickup apparatus 100 of the present embodiment further includes transparent liquid 14 configured to fill with the sealed space S₁. The transparent liquid 14 has an index of refraction, which is substantially equal to that of the first transparent plate 131 and the second transparent plate 132. In the present embodiment, the transparent liquid 14 can be gaseous state or be liquid state. Preferably, the transparent liquid 14 is glycerol having an index of refraction of 1.475. Therefore, direction of the light beam traveling from the first transparent plate 131 to the transparent liquid 14 and from the transparent liquid 14 to the second transparent plate 132 does not change due to the same indices of refraction of the first transparent plate 1 31, the transparent liquid 14 and the second transparent plate 132.

Furthermore, the image pickup apparatus 100 of the present embodiment can include a vibration detecting module (not shown) configured for detecting the vibration of the lens 11. Additionally, the image pickup apparatus 100 can further include a vibration measuring module (not shown) configured for measuring a value of optical axis displacement of the lens 11 caused by vibration. Particularly, the vibration detecting module and the vibration measuring module are electrically connected to the IC chip. That is, the operation of the vibration detecting module and the vibration measuring module is capable to be controlled by the IC chip.

For example, once the vibration of the image pickup apparatus 100 occurs, the IC chip receives a value of optical axis displacement of the lens 11 measured by the vibration measuring module. Then, a value of voltage necessary to be supplied to the piezoelectric elements 133 is determined based on the value of the optical axis displacement of the lens 11 and is modified through a predetermined function by the IC chip. The determined voltage is supplied to the piezoelectric elements 133 by the voltage sources, thereby causing the piezoelectric elements 133 to have a change in shape. The second transparent plate 132 is obliquely oriented in response to the shape changes of the piezoelectric elements 133. As a result, the optical path of light beam changed by the vibration can be redirected in the direction where the optical path of light beam should passing through. That is, a change in optical path caused by the vibration of the image pickup apparatus 100 is compensated.

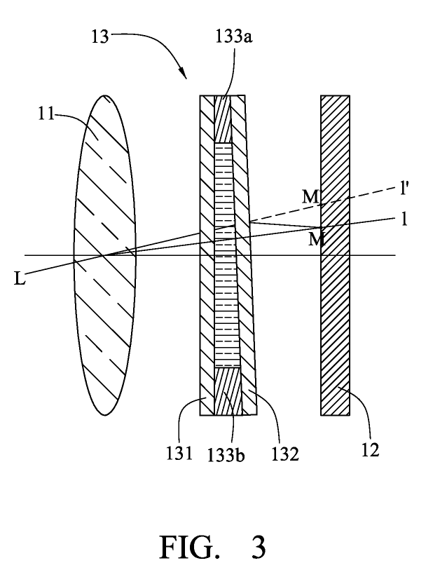

Referring to the FIG. 3, a schematic view of the mechanism of optical compensation is shown. Upon the condition where no vibration is occurred to the image pickup apparatus 100, the light beam L passes through the lens 11 and the optical compensation device 13 onto a point M of the image sensor 12. Once the vibration of the image pickup apparatus 100 occurs, the light beam L is shifted and falls onto a point M′ of the image sensor 12, consequently. That is, a point of the image representing one position of the object shifts from the point M to the point M′ due to the vibration of the image pickup apparatus 100. In such case, supplying voltage to the piezoelectric elements 133a, 133b by the voltage sources, respectively, allows the piezoelectric element 133a to be stressed and allows the piezoelectric element 133b to be strained. Thus, one side of the optical compensation device 13 has less distance between the first transparent plate 131 and the second transparent plate 132 while opposite side of the optical compensation device 13 has relative large distance between the first transparent plate 131 and the second transparent plate 132. That is, the second transparent plate 132 is obliquely oriented relative to the first transparent plate 131, so that a sectional view of the optical compensation device 13 is ladder-shaped, as shown in FIG. 3. Thus, the light beam L will be redirected when it passes through the deformed optical compensation device 13 so as to fall onto the point M of the image sensor 12. Particularly, when the light beam L passes the deformed optical compensation device 13, the shifted optical path is refracted so as to reach the point M of the image sensor 12.

Moreover, a number of the optical compensation device 13 accommodated in the housing 10 is not limited to one. For achieving optical compensations of two dimensions or in multiple dimensions, a plurality of the optical compensation devices can be disposed between the lens 11 and the image sensor 12.

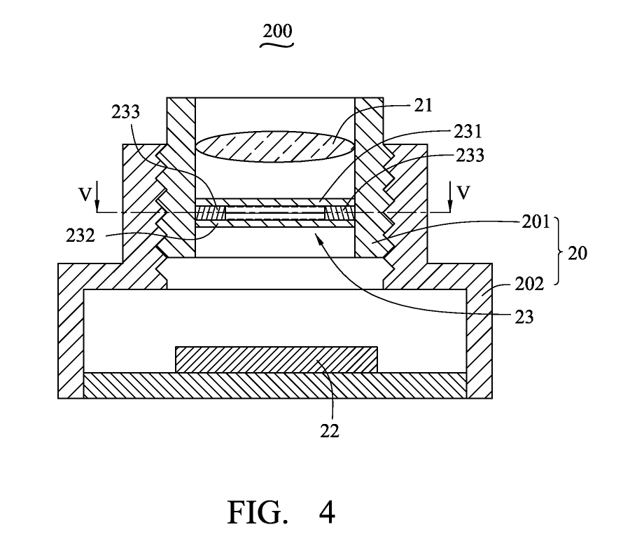

Referring to FIG. 4, an image pickup apparatus 200 in accordance with a second embodiment of the present invention, is shown. The image pickup apparatus 200 includes a housing 20, at least one lens 21, an image sensor 22 and an optical compensation device 23. The lens 21, the image sensor 22 and the optical compensation device 23 are accommodated in the housing 20. The optical compensation device 23 is disposed between the lens 21 and the image sensor 22. The optical compensation device 23 includes a first transparent plate 231, a second transparent plate 232 and at least one piezoelectric element 233.

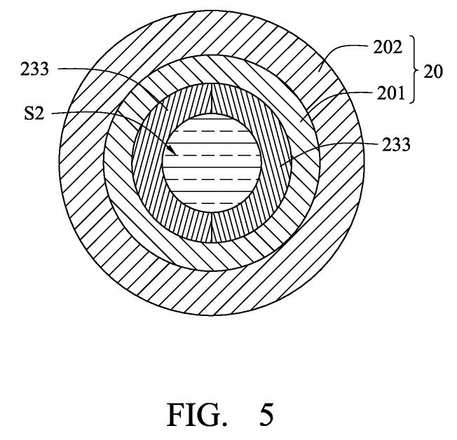

Because the image pickup apparatus 200 is similar to the image pickup apparatus 100, the detailed description is omitted for conciseness. The difference is that the optical compensation device 233 is accommodated in a barrel 201 of the housing 20. In addition, the optical compensation device 23 in the present embodiment includes the circular first transparent plate 231, the circular second transparent plate 232 and the semi-ringed piezoelectric elements 233, as shown in FIG. 5. As mentioned above, the first transparent plate 231, the second transparent plate 232 and the piezoelectric elements 233 are cooperatively form a sealed space S₂. The sealed space S₂ is filled with liquid having an index of refraction about the same as that of the first transparent plate 231 and the second transparent plate 232.

In conclusion, the image pickup apparatus utilizes at least one optical compensation device disposed between the lens and the image sensor to modulate the optical path of light beam once the vibration of the image pickup apparatus occurs. By way of allowing at least one piezoelectric element of the optical compensation device to have a change in shape, the displaced optical path caused by the vibration will be redirected into an optical path when there is no vibration occurring on the image pickup apparatus.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. An image pickup apparatus, comprising:
a housing;
at least one lens accommodated in the housing;
an image sensor accommodated in the housing; and
an optical compensation device disposed between the at least one lens and the image sensor, the optical compensation device comprising a first transparent plate, a second transparent plate opposite to and movable relative to the first transparent plate, and at least one piezoelectric element sandwiched between the first transparent plate and the second transparent plate.

2. The image pickup apparatus as claimed in claim 1, wherein the first transparent plate, the second transparent plate and the piezoelectric element cooperatively form a sealed space.

3. The image pickup apparatus as claimed in claim 1, further comprising an elastic element filled in interfacial gaps formed between the first transparent plate, the second transparent plate and the piezoelectric element.

4. The image pickup apparatus as claimed in claim 3, wherein the elastic element is selected from a group consisting of organic silicon gel, polysulfide gel and polyurethane gel.

5. The image pickup apparatus as claimed in claim 2, further comprising a transparent liquid filling the sealed space.

6. The image pickup apparatus as claimed in claim 5, wherein the transparent liquid has an index of refraction substantially equal to that of the first transparent plate or the second transparent plate.

7. The image pickup apparatus as claimed in claim 1, wherein the housing comprises a barrel and a holder connected with the barrel.

8. The image pickup apparatus as claimed in claim 7, wherein the optical compensation element is accommodated in the barrel.

9. The image pickup apparatus as claimed in claim 7, wherein the optical compensation element is accommodated in the holder.

10. The image pickup apparatus as claimed in claim 1, wherein the piezoelectric element is made of piezoelectric ceramic, piezoelectric crystal or piezoelectric polymer.

11. The image pickup apparatus as claimed in claim 1, wherein the first transparent plate or the second transparent plate is made of glass or plastic.

12. The image pickup apparatus as claimed in claim 1, wherein the first transparent plate and the second transparent plate are circular-shaped or rectangular-shaped.

13. The image pickup apparatus as claimed in claim 1, wherein the at least one piezoelectric element is annular-shaped or rectangular-shape.

14. An image pickup apparatus, comprising:
a lens;
an image sensor optically aligned with the lens; and
an optical compensation device disposed between the lens and the image sensor, the optical compensation device comprising a first transparent plate, a second transparent plate substantially parallel to the first transparent plate, and a piezoelectric element having a first end coupled to the first transparent plate and an opposite second end coupled to the second transparent plate, the piezoelectric element being deformable in a manner such that the first transparent plate is obliquely oriented relative to the second transparent plate.
